(19) United States
(12) Patent Application Publication
(10) Pub. No.: US 2009/0124478 A1
(43) Pub. Date: May 14, 2009

(54) Multi-Direction Carton Setup On A Single Direction Machine

(76) Inventor: Mark C. OLDENBURG, Hoffman Estates, IL (US)

Correspondence Address: MARK D MILLER;KIMBLE, MACMICHAEL & UPTON, 5260 NORTH PALM AVENUE, SUITE 221, FRESNO, CA, 93704, US

(21) Appl. No.: 11/791,355

(22) PCT Filed: Nov. 22, 2005
(86) PCT No.: PCT/US05/42630

§ 371 Date: May 21, 2007

Related U.S. Application Data
(60) Provisional application No. 60/631,637, filed on Nov. 29, 2004.

(51) Int. Cl. B31B 17/00

(52) U.S. Cl. 493/84

(57) ABSTRACT

An improved system and method for assembling cartons for containing various items. The present invention comprises a system that is capable of assembling a carton regardless of the direction in which the carton is intended to be assembled. By being able to assemble such cartons independent of the carton's intended design direction, manufacturers are able to greatly reduce costs associated with purchasing and housing multiple machines.

### CROSS-REFERENCE TO RELATED PATENT APPLICATIONS

The present application claims priority to U.S. Provisional Patent Application No. 60/631,637, filed Nov. 29, 2004 and incorporated herein by reference in its entirety.

### FIELD OF THE INVENTION

The present invention relates generally to the manufacture of packaging cartons. More particularly, the present invention is related to methods and systems for assembling cartons that are designed to be assembled in a particular direction.

### BACKGROUND OF THE INVENTION

Various types of automatic packaging machines are known and used for assembling paperboard and/or cardboard packages from precut box blanks. These packages can be used to hold a wide variety of items, ranging from chewing gum to candy to office supplies: U.S. Pat. Nos. 4,578,929; 4,548,593; 4,716,714; 4,829,751; 4,856,566; 4,982,556; 5,010,929; 5,072,573; 5,144,790; and 6,195,959 are examples of packaging machines which may be used to load small items into different types of packages.

Conventional automatic packing machines include a conveyor, usually an endless link chain conveyor, which travels through or past a number of work stations extending between a magazine containing package blanks and a product discharge end. Usually, the package blanks are a stack of die cut paperboard or cardboard blanks which are picked up one-at-a-time by vacuum cups and then put into package-forming mandrels carried by the conveyor. Panels and flaps on the bottom of the blank are folded by a series of plows and sealed in order to close the package. A predetermined amount of product is then placed in the package. Next, panels and flaps forming a top of the package are folded and sealed. Then the package is discharged onto any suitable conveyor, into a shipping carton, or to another device for receiving the completed product containing packaging.

Conventionally, a plow is a strip of metal, or the like, extending along a length of the conveyor and in a location where the panels and flaps are to be folded. First, panels and flaps forming the bottom of the package encounter the plows and then are folded as the conveyor carries the package past the plow. Then, a predetermined amount of product is placed in the package. Next, panels and flaps forming a top of the package are folded and sealed in a similar manner. Depending upon product packaging needs, the package may or may not be wrapped in a transparent film which is sealed. Finally, the package is discharged onto any suitable conveyor, into a shipping box or another suitable device for receiving the product containing package.

Often, the product presents special considerations which require the packaging machine to perform unique functions as the package is formed and filled. These functions may be performed by special parts which are attached to or positioned near the conveyor. Many examples of such special parts are shown and described in the above-cited patents.

Currently, packaging cartons are designed to be assembled in a specific direction. For example, some cartons are designed to be assembled by moving along a conveyor system from left to right, while other cartons are designed to be assembled by moving along a conveyor system from right to left. This characteristic creates a number of issues for carton and product manufacturers, as current packaging machines are only capable of assembling cartons in one direction. Because of this fact, carton and product manufacturers often must have two different machines on the factory floor in order to assemble two different lines of cartons. This requires a significant capital investment by the manufacturer, who is forced to purchase two different machines to assemble similar-type products. Two machines also take up significant floor space, which also adds to the manufacturer's operating costs.

It would therefore be desirable to develop a packaging machine that can assemble packaging cartons regardless of the direction in which the cartons are intended to be assembled.

### SUMMARY OF THE INVENTION

The present invention provides for a system and method for assembling cartons regardless of the direction in which the carton is intended to be assembled. To switch from having the machine assemble cartons in the “reverse” direction to the “forward” direction, the rotary feeder and the carton magazine of the device are rotated, by about 60 degrees in one embodiment of the invention, to the forward carton setup position. The rotary feeder gearbox is then switched to the counter rotating direction.

These and other objects, advantages and features of the invention, together with the organization and manner of operation thereof, will become apparent from the following detailed description when taken in conjunction with the accompanying drawings, wherein like elements have like numerals throughout the several drawings described below.

### BRIEF DESCRIPTION OF THE DRAWINGS

FIG. 1 is top view a carton packaging system constructed according to one embodiment of the present invention; and

FIG. 2 is an exploded view of the carton packaging system of FIG. 1.

### DETAILED DESCRIPTION OF THE PREFERRED EMBODIMENTS

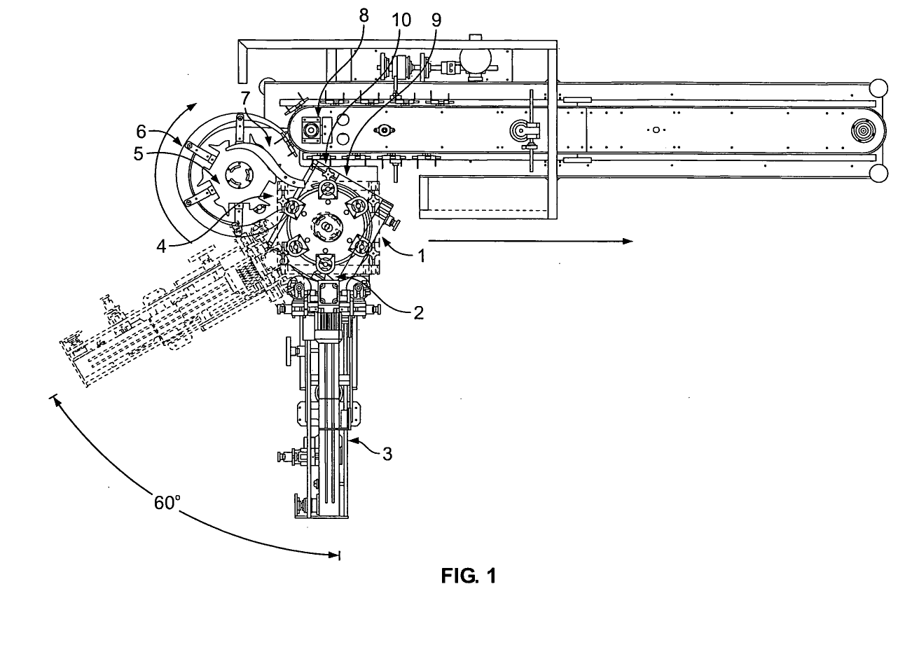

FIG. 1 is a top view of a carton packaging system constructed in accordance with one embodiment of the present invention. The system includes a rotary feeder 1 which is operatively connected to a vacuum pickup 2 and a carton magazine 3. The vacuum pickup 2 is used to capture and hold the carton to be assembled inside from the carton magazine 3. When captured, the carton fits at least partially within a carton pocket 4, which is part of a star wheel 5 that is rotatable in either the forward direction or the reverse direction, depending upon the direction of assembly at a particular moment. A center guide 6 is used to guide the star wheel 5 as it rotates to a carton track carton pocket 7 on a carton track 8. Once the star wheel 5 rotates to the transfer position, the carton is transferred to the carton track carton pocket 7. A transfer guide 9 is used to assist in this process.

According to one embodiment of the present invention, the operation of the system in the “reverse” and “forward” directions are generally as follows. It should be noted that the terms “forward” and “reverse” are used to distinguish the different directions of operation and are not intended to designate any preference between directions.

For the “reverse” direction, the rotary feeder 1 acquires a carton blank using the vacuum pickup 2 from the carton magazine 3. The carton magazine can be positioned in either a “forward” position or a “reverse” setup position, depending upon the direction of assembly at a given moment. In one embodiment of the invention, the carton magazine 3 moves about sixty degrees between the forward setup position and the reverse setup position. The rotary feeder 1 then rotates, along with the carton which is attached to the vacuum pickup 2, to the carton pocket 4 on the carton star wheel 5. The carton is setup using standard carton setup mechanics in the pocket 4 of the star wheel 5, which is rotating in the opposite direction of the normal carton travel direction of the carton track 8 as indicated. The carton is guided by the center guide 6 as the star wheel 5 rotates to the carton track carton pocket 7 on the carton track 8. The carton is then transferred from the star wheel carton pocket 4 to the carton track carton pocket 7. The carton transfer is assisted by the transfer guide 9 during the transfer process.

To switch to “forward” direction, the rotary feeder 1 and the carton magazine 3 are rotated, by about sixty degrees in one embodiment of the invention, to the forward carton setup position. The rotary feeder gearbox is then switched to the counter rotating direction. When operating, the rotary feeder 1 acquires a carton blank with the vacuum pickup 2 from the carton magazine 3. The rotary feeder 1 then rotates, with the carton attached to the vacuum pickup 2, to a carton pocket setup position 10 on the carton track 8. The carton is setup using the standard carton setup mechanics in the pocket of the carton track 8, which is moving in the normal carton travel direction of the carton track 8 as indicated.

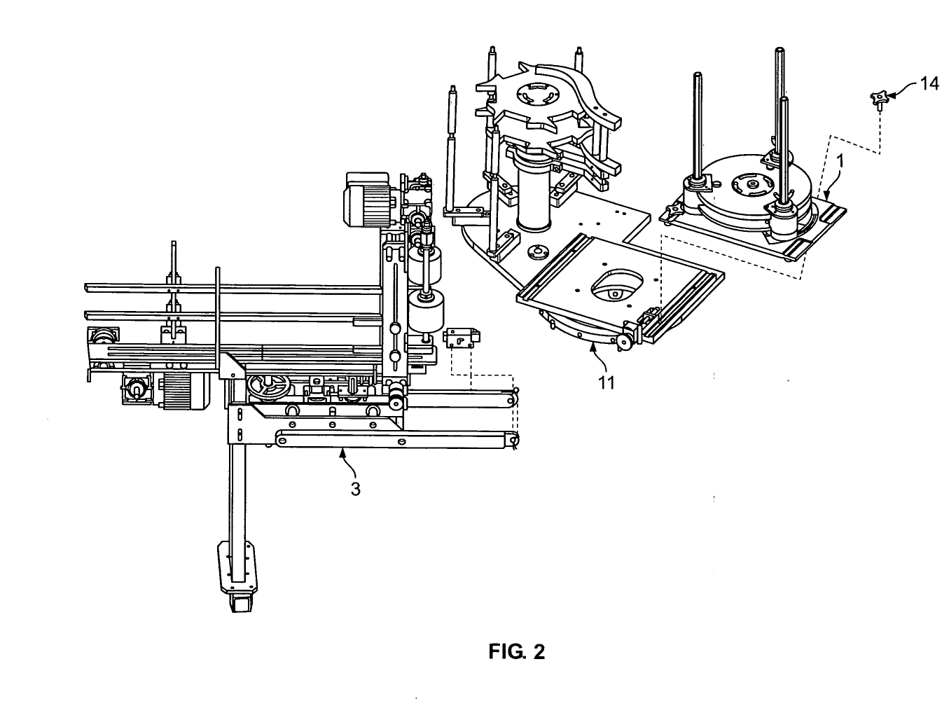

As shown in FIG. 2, the system also includes a base plate assembly 11, which is secured to the rotary feeder 1 with the assistance of a clamp knob 14. Other components are also shown in FIG. 2.

The foregoing description of embodiments of the present invention have been presented for purposes of illustration and description. It is not intended to be exhaustive or to limit the present invention to the precise form disclosed, and modifications and variations are possible in light of the above teachings or may be acquired from practice of the present invention. The embodiments were chosen and described in order to explain the principles of the present invention and its practical application to enable one skilled in the art to utilize the present invention in various embodiments and with various modifications as are suited to the particular use contemplated.

What is claimed is:

1. An apparatus for assembling a carton, comprising:
a rotary feeder operatively connected via a pickup to a carton magazine configured to hold a carton blank, the pickup positionable to capture and hold the carton blank; and
a multidirectional assembly having at least one carton pocket adapted to hold the carton blank, the multidirectional assembly possessing a first direction of travel and a second direction of travel and being in operative communication with the rotary feeder and a carton track for transferring assembled cartons from the multidirectional assembly;
wherein the carton track includes a carton track carton pocket for receiving an assembled carton from the star wheel and the carton blank is assembled in the multidirectional assembly carton pocket, and wherein the assembled carton is transferred to the carton track after assembly in the multidirectional assembly carton pocket.

2. The apparatus for assembling a carton of claim 1, wherein the multidirectional assembly is a star wheel.

3. The apparatus for assembling a carton of claim 2, wherein the pickup comprises a vacuum pickup device.

4. The apparatus for assembling a carton of claim 2, further comprising a star wheel gearbox for selectively controlling the direction of travel of the star wheel.

5. The apparatus for assembling a carton of claim 2, further comprising a transfer guide in operative communication with the star wheel and the carton track, the transfer guide assisting in transfer of the assembled carton to the carton track.

6. The apparatus for assembling a carton of claim 2, further comprising a base plate assembly secured to the rotary feeder and in communication with the star wheel.

7. The apparatus for assembling a carton of claim 2, further comprising a center guide in communication with the star wheel, wherein the center guide guides the star wheel during rotation.

8. A method for multidirection carton setup, comprising:
acquiring in a rotary feeder a carton blank from a carton magazine via a pickup;
choosing a direction of operation of a star wheel assembly relative to a direction of travel of a carton track;
rotating the rotary feeder to transfer the carton blank to a carton pocket in the star wheel assembly;
positioning the carton blank in the star wheel carton pocket for assembly;
assembling the carton blank in the star wheel carton pocket; and
transferring the assembled carton to the carton track for transporting the assembled carton from the star wheel assembly.

9. The method of claim 8, further comprising, if the chosen direction of operation is not a current direction of operation of the star wheel assembly, switching the direction of operation of the star wheel assembly.

10. The method of claim 9, wherein the star wheel assembly comprises a gearbox for controlling the direction of operation.

11. The method of claim 10, wherein the gear box allows for selective operation in both a forward direction and a reverse direction

12. The method of claim 11, wherein the switching of the direction of operation comprises rotating the carton magazine with respect to the rotary feeder and switching the gear box from the forward direction to the reverse direction or from the reverse to the forward direction.

13. The method of claim 12, wherein the switching of the direction of operation further comprises rotating the carton magazine about 60 degrees.

14. A method for setting up a carton blank for transfer on a carton track, comprising:
capturing the carton blank with a vacuum pickup;
choosing a direction of operation of a multidirectional assembly in relation to a direction of operation of the carton track;
transferring the carton blank to one of a plurality of carton pockets of the multidirectional assembly;
positioning the carton blank in one of the plurality of carton pockets for assembly; and
assembling the carton blank in a star wheel carton pocket.

15. The method of claim 14, further comprising transferring the assembled carton to the carton track for transportation.

16. The method of claim 15, wherein the carton track comprises at least one carton track carton pocket, and wherein the transferring of the assembled carton comprises transferring the assembled carton to one of the at least one carton track carton pocket.

17. The method of claim 15, wherein the transferring of the assembled carton includes operation of a transfer guide in operative communication with the plurality of multidirectional assembly carton pockets and the at least one carton track carton pocket

18. The method of claim 15, further comprising, if the chosen direction of operation is not a current direction of operation, switching of the direction of operation.

19. The method of claim 18, wherein a multidirectional assembly gear box allows for selective operation in a forward direction and a reverse direction

20. The method of claim 19, wherein the switching of the direction of operation comprises:
rotating the carton magazine with respect to the rotary feeder; and
switching the gear box from one of the forward direction to the reverse direction and from the reverse direction to the forward direction.
